(19) United States
(12) Patent Application Publication
(10) Pub. No.: US 2011/0076636 A1
(43) Pub. Date: Mar. 31, 2011

(54) DEVICE AND METHOD FOR DENTAL WHITENING

(76) Inventors: Andy Wolff, Harutzim (IL); Ben-Zion Beiski, Kiryat-Ono (IL)

(21) Appl. No.: 12/891,746

(22) Filed: Sep. 27, 2010

Related U.S. Application Data
(60) Provisional application No. 61/277,519, filed on Sep. 28, 2009.

(51) Int. Cl. A61C 19/06

(52) U.S. Cl. 433/27; 433/29; 433/215

(57) ABSTRACT

Embodiments of the invention provide a portable dental whitening device. The device comprises a flexible mouthpiece including a bite platform having a horseshoe shape adapted to receive a plurality of mouth shapes. The mouthpiece comprising at least one lighting element for generating light, at least one heating element for generating heat, a flexible printed circuit board, and at least one temperature sensor for detecting the temperature of the heat generated by the at least one heating elements. Further, the device comprises a control unit for selectively powering said lighting element and said heating element. The dental whitening is achieved by applying simultaneously the light and the heat and the chemical activity delivered by a whitening agent provided in the mouthpiece.

### CROSS REFERENCE TO RELATED APPLICATIONS

This application is a Non-Provisional application of a U.S. Provisional Application Ser. No. 61/277,519 entitled ‘Self-contained, Self-adjusted, Portable Appliance for Dental Whitening’ and filed on Sep. 28, 2009. The entire teachings of the above application are incorporated herein by reference.

### FIELD OF THE INVENTION

The invention relates to device and method for dental whitening. More specifically, the invention relates to device and method for dental whitening by using illumination and heat.

### BACKGROUND OF THE INVENTION

Tooth discoloration is a common problem known worldwide. Tooth discoloration may be caused due to various reasons. For example, the teeth may become stained by coffee or tea drinking, or by the use of tobacco products, or by drinking water with a high mineral content. In addition, genetic diseases such as dentinogenesis imperfecta, dentine dysplasia or some forms of amelogenesis imperfect may also cause tooth discoloration or staining. Further, some acquired fetal and post-natal pathologies occurring during tooth formation such as medical diseases (i.e., icterus, congenital erythropoietic porphyria, cholestasis, and renal diseases), treatments with tetracycline, or chronic ingestion of fluoride during childhood, may induce tooth discoloration.

One solution to the staining problem is through tooth bleaching. Various professional and commercial services and products exist for whitening teeth to remove staining. For example, the easier and more accessible source of teeth whitening products are the over-the-counter teeth whitening products, such as toothpastes with baking powder, gels, and more recently ‘strips’ for applying on teeth. Although these commercial products may be more affordable than using professional dental services, these products are usually not quite as effective as professional services and usually take more time to create the desired whitening the teeth.

Professional dental bleaching can be done either in a dental office or at home with the use of tooth whitening agents. The tooth whitening agents are mostly based on the effects of carbamide peroxide, which release about 33% of their content as hydrogen peroxide (H₂O₂). Hydrogen peroxide can act as a powerful oxidizing agent and can give rise to agents known to be effective bleaching agents, which include corresponding monoanion (HO₂−) and hydroxyl radical (OH) of hydrogen peroxide. In addition, carbamide peroxide releases urea, which is rapidly decomposed into carbon dioxide and ammonia. Chemical reaction of the two reagents with the tooth's components, including pigments or chromophores, constitutes the chemical basis of tooth whitening.

A tooth is comprised of outer hard enamel and an inner dentin layer, which are highly mineralized tissues. However, an organic non-mineralized matrix constitutes 0.6% in weight and 4% in volume of the total human adult enamel. It is well documented that urea degrades the organic matrix located in the enamel. Urea and ammonium ions (NH₄+) act on the hydrogen bounds that are crucial for the structure of matrix proteins. After the initial alteration, the degraded proteins are further split into small peptides, released, and finally eliminated from the enamel. The same applies to many dentin matrix components. The empty minute spaces that are rendered accessible by urea allow the diffusion of hydrogen peroxide throughout the whole thickness of enamel up to the Dentino-Enamel Junction (DEJ). Bleaching agents cross the DEJ and interact in the subjacent dentin with the chromophores, pigments, and ions that are cause tooth staining.

For home dental bleaching, a dental professional creates a customized device using a mold taken from teeth of a user (see for example, U.S. Pat. No. 5,165,424 to Silverman). This device is used to completely cover the teeth of the user and must be used in combination with a chemical gel during treatments. Further, the procedure may be required to be repeated every night while sleeping for several months to achieve the desired effect.

Another solution for whitening the teeth is to use light. Light treatment significantly lightens the color of teeth to a greater extent than using peroxide alone. See “Light augments tooth whitening with peroxide”, Journal of American Dental Association, 2003, Tavares M. et al. Thus, another known service has the dental professional apply a chemical whitener and, in addition, light or heat to enhance the whitening effect in a shorter duration of time. For example, U.S. Pat. No. 7,572,124 and U.S. Patent Application No. 2008/0032252 assigned to Discus Dental, LLC, provide illumination devices for dental whitening. A variety of light-activating systems are employed for activating the 35 to 50% hydrogen peroxide-based bleaching agents. However, concern has been raised about the thermal effects of such techniques on the dental pulpal tissues. The dental pulpal tissue or pulp is the most inner dental structure, composed by soft tissue, blood vessels and nerves. The thermal effects may result in an excessive heating of the dental pulpal tissue, which increases the chances of postoperative sensitivity. Further, according to Luk et al., in “Effect of light energy on peroxide tooth bleaching”, Journal of American Dental Association, 2004, the application of lights significantly improves the whitening efficacy of some bleach materials, however it causes significant temperature increases in the outer and inner tooth surfaces. Typically, temperature elevations of 5.6° Celsius (C.) or greater can cause damage of pulpal tissues and may result in necrosis (pulpal death) in 15% of cases, depending on pulp health and its physiological response capacity. Recent studies by Carrasco T G et al., “In vitro study of the pulp chamber temperature rise during light-activated bleaching”. Journal of Applied Oral Science, 2008 and Kabbach W et al., “A thermal investigation of dental bleaching in vitro”, Photomed Laser Surgery, 2008, have demonstrated that the irradiation of tooth surfaces by Light Emitting Diodes (LEDs) increase the pulpal temperature by less than 3° C., which is well below threshold of temperature that would damage the pulpal tissue. Generally, the LED-systems available for light-activated bleaching consist of multiple LEDs mounted side by side. The LEDs emit light that is distributed across a bandwidth of 20 nanometer to 80 nanometer and more. See, “External bleaching therapy with activation by heat, light or laser—a systematic review”, Buchalla et al., Dental Materials, 2007.

The drawbacks of these techniques are substantial costs and discomfort to the patients, derived from the need to perform the procedure in a dental office. Typically, dental bleaching in a dental office takes a long time, sometimes amounting to more than an hour per single visit to the dental office. Additionally, this can be an uncomfortable experience for the patients. Some in-office products lighten teeth immediately to the same degree as with bleaching using at-home tray-based bleaching agents. However, the color reversal in most of the in-office products occurs more rapidly than in at-home tray-based bleaching products. See “Eight in-office tooth whitening systems evaluated in vivo: a pilot study”, Matis B A et al., Operative Dentist, 2007.

It would, therefore, be desirable to have an efficient and comfortable technique for dental whitening at the patient's home. Further, the techniques should provide a generic device that is suitable for most whitening trays and gels. Such techniques have been disclosed in U.S. Pat. No. 7,331,784 assigned to Futek, Inc., U.S. Pat. No. 7,422,598 assigned to Palomar Medical Technologies, Inc., U.S. Patent Application No. 2006/0019214 to Lawrence, and U.S. Patent Application No. 2007/0015112 to Hochman.

U.S. Pat. No. 7,331,784 discloses a method to provide tooth whitening by a mouthpiece including a light irradiation section for irradiating the front surfaces of teeth. The mouthpiece can be attached to the teeth, and the front teeth are irradiated with a blue light or ultraviolet light emitted from an LED, to whiten the teeth. Further, an electronic cable connects the mouthpiece to a controller, which is held in one hand. Therefore, the device is easy to handle and the teeth whitening process can be performed at home. However, the technique fails to disclose the chemical reaction for achieving the desired effect of tooth whitening. Moreover, there is no scientific evidence for a teeth whitening effect by irradiating teeth without using a chemical tooth whitening agent.

U.S. Pat. No. 7,422,598 and U.S. Patent Application No. 2006/0019214 disclose oral lightening devices. The devices include a handle that allows the patient to grip a mouthpiece. Further, the devices can contain an electrical power supply, such as a battery and a control switch. The mouthpieces contain optical radiation sources to provide phototherapeutic radiation to the surface of the patient's teeth that are coated with the tooth whitening agent. As a result, a chemical reaction occurs, which enhances and/or expedites the tooth whitening effect.

The device of U.S. Pat. No. 7,422,598 is provided with one or more bristles that are optically coupled to the radiation emitter to receive and propagate the phototherapeutic radiation. The device further contains a thermally conductive element for extracting heat from the emitter. However, these features make the device very bulky to fit comfortably into the mouth of the patient. Moreover, heat may not be properly provided, resulting in a poor whitening effect. Furthermore, the patent discloses that teeth whitening can be used with chromophores to improve tooth whitening effectiveness. However, no reference is provided in support of the effectiveness of chromophores to achieve tooth whitening effect. The electromagnetic radiation source apparatus in U.S. Patent Application No. 2006/0019214 is not secured directly to the teeth to be irradiated. Instead, the apparatus is mechanically connected by a locking mechanism to the mouthpiece containing tooth whitening agent. However, the mouthpiece is made of plastic. Therefore, the locking mechanism may provide poor stability to the electromagnetic radiation source.

U.S. Patent Application No. 2007/0015112 describes a dental whitening apparatus. The apparatus include a body having a heating element and a light emitting device. The heating element and the light emitting device are disposed for activating a bleaching composition. Further, a mouthpiece is connected with the body. The mouthpiece includes a dental receiving area that is formed of a material that facilitates transmission of light, and is contoured to a set of teeth. The dental receiving area has a first wall and a second wall that define a cavity for disposal of the bleaching composition. Many times not all the teeth need the same whitening procedure or are enlightened at the same rate. Moreover, sometimes not the entire tooth surface needs the same degree of whitening treatment, as staining may not be uniform. U.S. Patent Application No. 2007/0015112 and other techniques discussed above fail to teach selective irradiation of teeth that need to be whitened. Moreover, none of the above described techniques disclose a mechanism to perform teeth whitening by bleaching with only light or light combined with heat.

U.S. Pat. No. 4,952,143 to William J. Becker, discloses a temperature probe proximal to a reflector lamp for bleaching the teeth. However, the temperature probe is not implemented on a mouthpiece. U.S. Pat. No. 7,422,598 assigned to Palomar Medical Technologies, Inc., discloses an oral phototherapy applicator that includes temperature sensors monitoring temperature within an oral cavity. However, the applicator is implemented as a toothbrush and needs maneuvering by the patient for dental whitening.

It is therefore desirable to have techniques that overcome the above mentioned drawback and provide effective dental whitening.

### SUMMARY

Embodiments of the invention provide a portable dental whitening device. The device comprises a flexible mouthpiece including a bite platform having a horseshoe shape adapted to receive a plurality of mouth shapes. The mouthpiece comprising at least one lighting element for generating light, at least one heating element for generating heat, a flexible printed circuit board, and at least one temperature sensor for detecting the temperature of the heat generated by the at least one heating elements. Further, the device comprises a control unit for selectively powering said lighting element and said heating element.

Embodiments of the invention provide a dental whitening device comprising a flexible mouthpiece and a control unit. The mouthpiece comprising: a bite platform having a horseshoe shape; at least one lighting element configured to generate light; at least one heating element configured to generate heat; a flexible printed circuit board; and at least one temperature sensor configured to detect the temperature of the heat generated by said at least one heating elements. The control unit is configured to activate said at least one lighting element and said at least one heating element, based on a pre-stored selection and pre-stored sequence; and control the temperature of the heat generated by said at least one heating elements, based on a predefined temperature range.

Embodiments of the invention provide a method for whitening of teeth. The method comprises: providing a portable dental whitening device, wherein the device comprises a mouthpiece and a control unit, and wherein the mouthpiece comprises at least one lighting element, at least one heating element, a printed circuit board and a bite platform having a horseshoe shape; placing tooth whitening agent on a dental tray; securing the dental tray on one or more teeth of a patient, whereby the tooth whitening agent coats at least one tooth; securing the portable dental whitening device to one or more teeth of the patient by occluding the teeth on the bite platform; activating said at least one lighting element and said at least one heating element by using the control unit; and exposing the at least one tooth with light generated by said at least one lighting element and heat delivered by said at least one heating element, wherein the dental tray permits the light and heat to cause a reaction with the tooth whitening agent in order to whiten the at least one tooth of the patient.

An aspect of the present invention is a self-contained, self-adjusted, flexible and portable dental whitening device.

Another aspect of the present invention is to provide a dental whitening device that can be used by professionals and non-professional users at home or elsewhere.

Another aspect of the present invention is that the device can fit into every mouth shape without requiring any adaptations or modifications. Moreover, most existing whitening gels and transparent dental tray for placing a tooth whitening agent can be employed with the device.

Another aspect of the present invention is that the lighting elements that can be selected in any combination to produce several wavelengths to achieve the desired results. The lighting elements can generate light at ultraviolet, visible and infrared spectrums.

Another aspect of the present invention is that the mouthpiece includes a horseshoe shaped bite platform. The bit platform contains slits that allow self-adjustment of the mouthpiece shape to the shape of to the patient's mouth.

Another aspect of the present invention is that the control unit contains a programmable unit that can be programmed to enable the lighting elements to emit light and/or deliver heat from heating elements based on a pre-stored selection.

Clinical trials have revealed that the combination of heat and illumination of the whitening agent (and the teeth) accelerates the whitening effect significantly and produces better whitening results in a shorter time period. However, the teeth may separate from tissue as a result of high sensitivity to excessive temperature. Therefore, exposing the teeth to temperature over about 42 degrees centigrade for a long period of time, can damage the tissue and may cause irreversible damage and pain. As a result, exposing the teeth to heat without controlling and/or limiting the temperature applied on the teeth, is a major safety issue. The embodiments of the invention described herein, address this major issue and provide temperature sensor(s) at the mouthpiece close to the teeth and the gums, and a temperature control unit for controlling and/or limiting the temperature.

Other systems, methods, features, and advantages of the present invention will be or become apparent to one with skill in the art upon examination of the following drawings and detailed description.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating various components of a dental whitening device, in accordance with an embodiment of the invention;

FIG. 2 is a side view of the dental whitening device, in accordance with an embodiment of the invention;

FIG. 3 is a front view of the device, in accordance with an embodiment of the invention;

FIG. 4 is an isometric view of the device, in accordance with an embodiment of the invention;

FIG. 5 is a front close-up view of a mouthpiece of the device, in accordance with an embodiment of the invention;

FIG. 6 is an isometric view of the device supporting impression material on a bite platform of the mouthpiece, in accordance with an embodiment of the invention;

FIG. 7 is an exemplary upper view of a segment of teeth for perforating the impression material corresponding to a tooth that is desired to be whitened;

FIG. 8a is an exemplary front view of a tooth, illustrating lighting elements placed on front of the tooth;

FIG. 8b is an exemplary front view of the tooth covered, illustrating heating elements placed on front of the tooth;

FIG. 9 is a view of superior and inferior dental trays as mounted on a teeth mold;

FIG. 10 is an isometric view of a cradle of the device, in accordance with an embodiment of the invention;

FIG. 11 is an exemplary view of the device connected to an external device through the cradle, in an embodiment of the invention; and

FIG. 12 is a block diagram illustrating a method for dental whitening, in accordance with an embodiment of the invention.

### DETAILED DESCRIPTION OF THE INVENTION

In the detailed description that follows, corresponding components have been given the same reference numerals, regardless of whether they are shown in different embodiments or views of the inventions described herein. To illustrate the various aspects of the inventions in a clear and concise manner, the drawings may not necessarily be to scale and certain features may be shown in somewhat schematic form.

The principles and operation of a device and method for dental whitening according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

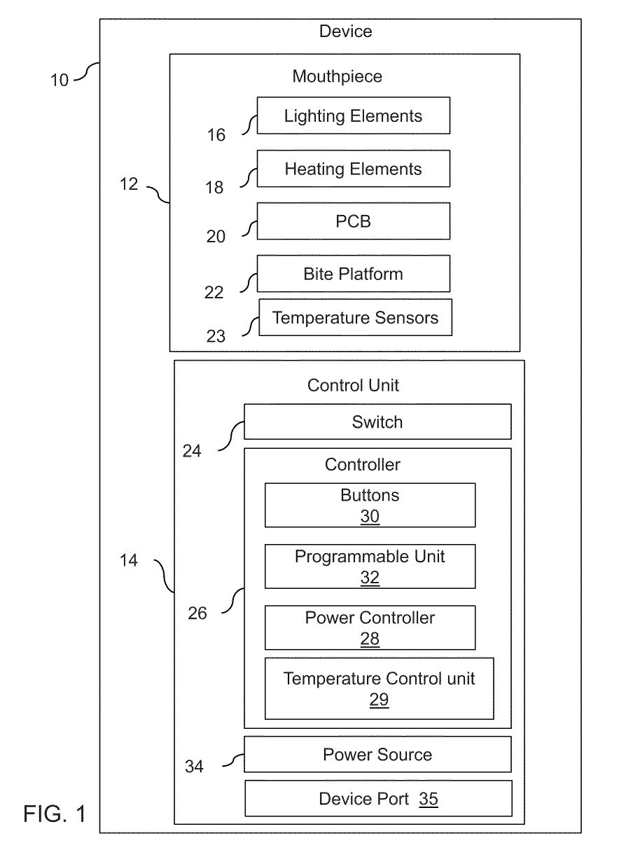

FIG. 1 is a block diagram illustrating various components of a dental whitening device 10, in accordance with an embodiment of the invention. Device 10 can be used by a patient to treat discoloration or perform whitening of teeth. The whitening of teeth is achieved by using light and heat provided by device 10 on teeth selected by the patient. Device 10 includes a mouthpiece 12 and a control unit 14. Mouthpiece 12 includes lighting elements 16, heating elements 18, a Printed Circuit Board 20, and a bite platform 22, and temperature sensors 23. Lighting elements 16 may include for example, Light Emitting Diodes (LEDs) for generating light, and heating elements 18 may include, for example, Surface Mounted Device (SMD) resistors, or ‘Joule Effect’ components for generating heat on the teeth desired to be whitened. Bite platform 22 is a horseshoe shaped platform for adapting to the shape of the mouth and providing support to the teeth of a patient. Temperature sensors 23 determine the temperature of the heat generated by heating elements 18. Temperature sensors 23 may be, for example chip thermistors or thermocouples for measuring the temperature. PCB 20 acts as a circuit board for functioning of lighting elements 16 and heating elements 18. Further PCB 20 may be connected to control unit 14 through electric cables (not shown).

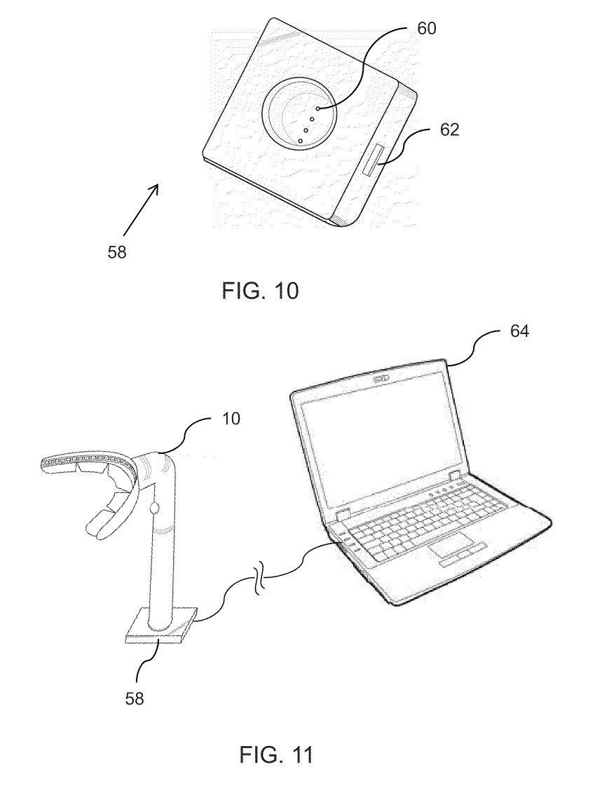

Control unit 14 provides and controls the power to lighting elements 16 and heating elements 18. Further, control unit 14 may selectively provide power based on the selection by the patient or a pre-stored selection. Moreover, control unit 14 controls the temperature of the heat generated by heating elements 18. Control unit 14 includes a switch 24 to activate control unit 14 for powering-on or powering-off lighting elements 16 and heating elements 18 (here after collectively known as Lighting-Heating (LH) elements 19). Examples of switch 24 include, but are not limited to, an on/off knob, a rotating switch with on/off function and so forth. Further, control unit 14 includes a controller 26 for controlling power supplied to LH elements 19. Further controller 26 enables other functions for control unit 14, such as a power controller 28. Power controller 28 may include for example, a pulse width modulator, a pulse frequency modulator, and a potentiometer. Power controller 28 may control the current and voltage supplied by control unit 14. Buttons 30 of control unit 14 enable the patient to select LH elements 19 for performing whitening of desired teeth and area of the teeth. In an embodiment of the invention, buttons 30 may be accompanied by a display (not shown) for displaying a number corresponding to LH element 19 selected by pressing buttons 30. Examples of the display include, but are not limited to, a two character LED display. Further, control unit 14 may include device ports 35 for connecting device 10 to an external device through a cradle. Therefore, device 10 can communicate with the external device to transfer data such as programming information. Programming information may include parameters, for example the LH elements 19 to be activated, duration of activation/powering, intensity of light and heat and so forth. As a result, the patient can select the parameters from the external device that can configure device 10. The cradle and communication of device 10 with the external device are explained in conjunction with FIGS. 10 and 11.

A temperature control unit 29 controls the temperature of the heat generated by heating elements 18. Temperature control unit 29 receives the values of temperature from temperature sensors 23 and controls the temperature within a predefined temperature range. For example, the predefined temperature range can be, for example 41 degrees Centigrade (C) to 42 degrees C.

In case, the temperature is more the predefined temperature range, then temperature control unit 29 can power down heating elements 18. In an embodiment of the invention, temperature control unit 29 can selectively power down heating elements 18 based on the individual temperature of heating elements 18. Moreover, temperature control unit 29 may power-on heating elements 18 when the temperature drops down to less than the predefined temperature range. As a result, the temperature of the heat generated is maintained, which makes the dental whitening process more efficient, safer and accelerated. Temperature control unit 29 may be for example, a programmable component such as, but not limited to, a microprocessor, an Application Specific Integrated Controller (ASIC), an electric circuit and so forth.

Control unit 14 includes a programmable unit 32 to selectively power LH elements 19 based on a pre-stored selection. Further, programmable unit 32 may enable the patient to store the selection for repeated treatment. Examples of programmable unit 32 include, but are not limited to, a microprocessor, an Application Specific Integrated Controller (ASIC) and so forth. In an embodiment of the invention, programmable unit 32 may include a memory (no shown) for storing the selection and a predefined default selection. Device 10 may be powered from a power source 34 included in control unit 14. Examples of power source 34 include, but are not limited to, batteries, rechargeable batteries such as Lithium-ion (Li-ion), Nickel Metal Hydride (NiMH) batteries, and so forth. The rechargeable battery may be recharged by an alternating current adapter or a base unit (not shown). In an embodiment of the invention, device 10 may be powered from external power supply, such as alternating current supply at a home of the patient. For example, power may be converted from 100 Volts Alternating Current (VAC) to 240 VAC to 1.2 to 14 V Direct Current (DC). Further, the output voltage of power source 34 may vary depending upon the power requirements of device 10. Typically, the voltage may range from 1.2V to 4.65V or 12V if the lighting elements 16 are implemented are cascades. The various other functions of the components of device 10 are discussed in conjunction with the figures and description below.

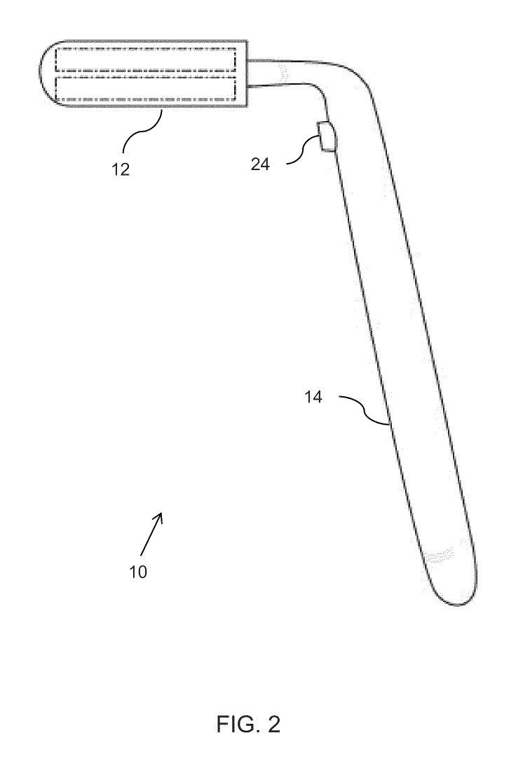

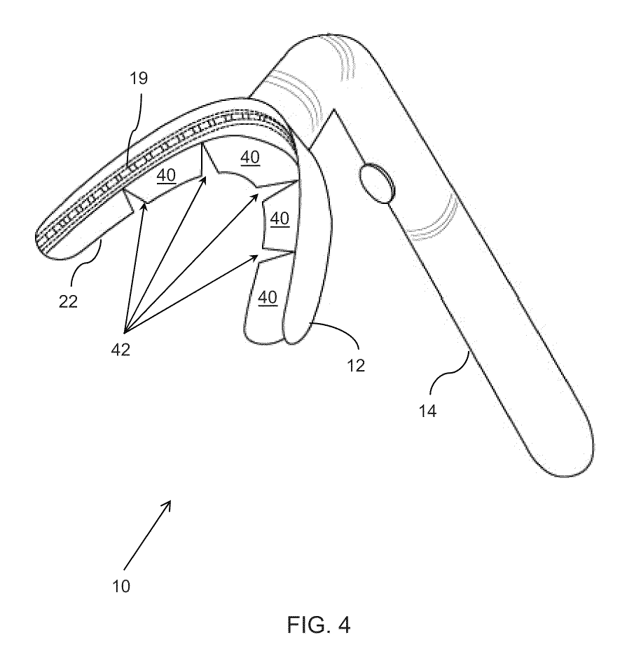

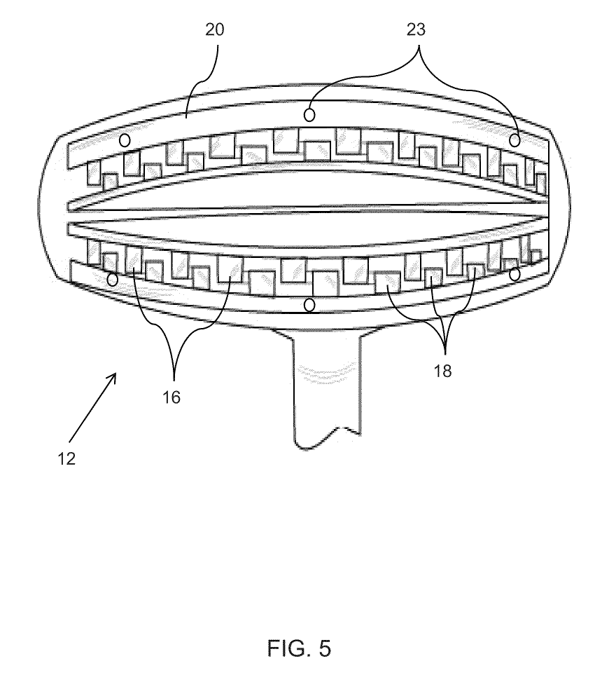

With reference to FIG. 2, a side view of device 10 is illustrated. As shown, device 10 is self-contained, adjustable, and portable. Mouthpiece 12 is made of a material that can be used in intra-oral functions. Further, mouthpiece 12 is secured firmly to control unit 14. Therefore, the patient may not be required to provide support to device 10 by hands. Control unit 14 is formed from a plastic material to fit comfortably in the hand of the patient and is resistant to breaking upon impact. The functions and design of mouthpiece 12 is explained in detail in conjunction with FIGS. 4 and 5.

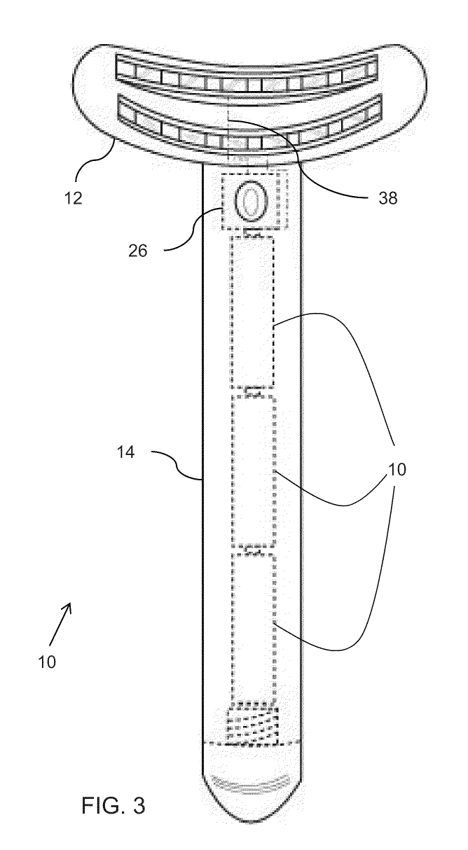

FIG. 3 is a front view of device 10, in accordance with an embodiment of the invention, representing the aspect of device 10 from the patient's point of view. As shown, control unit 14 includes power source 34 in the form of three batteries 36, switch 24 and an electric cable 38 connected to mouthpiece 12. Further, control unit 14 includes controller 26 for controlling the power supplied to LH elements 19. Although, as shown power source 34 includes batteries, a person skilled in the art will appreciate that the power can be supplied by an external source. Switch 24 powers on or off LH elements 19. For example, when LH elements 19 are off, then pressing switch 24 will power-on them.

FIG. 4 is an isometric view of device 10, in accordance with an embodiment of the invention, representing a lateral-superior view from the perspective of the patient's mouth. Mouthpiece 12 contains a number of lighting elements 16, heating elements 18 and bite platform 22. As shown, bite platform 22 is a horseshoe shaped bite platform, which is light weight to ensure that device 10 is securely fastened during use, when the patient is biting down on bite platform 22. As a result, the patient is not required to provide additional support with a hand during the use of device 10. Bite platform 22 includes various segments 40 by slits 42 to provide flexibility to mouthpiece 12. Therefore, mouthpiece 12 can be self-adjusted to fit mouth shapes or dental arches of diverse shapes. In an embodiment of the invention, mouthpiece 12 is adapted to the mouth shapes by using a boil and bite method.

FIG. 5 is a front close-up view of mouthpiece 12, in accordance with an embodiment of the invention, representing an anterior profile view from the perspective of the patient. Providing light and heat to the teeth desired to be whitened enhances and/or expedites the tooth whitening process by inducing chemical reactions with whitening agent. As shown, mouthpiece 12 includes lighting elements 16, heating elements 18, and PCB 20. Lighting elements 16 may generate light at any wavelength ranging between 200 nanometers and 1100 nanometers. For example, the wavelength may be in the visible spectrum (that is, from about 400 nanometers to about 700 nanometers), in the infrared spectrum (that is, from about 700 nanometers to about 1100 nanometers), in the ultraviolet spectrum with a typical peak wavelength of less than 300 nm, or in a combination of the above wavelengths. Further, the intensity of the generated light can be varied. In an embodiment of the invention, lighting elements 16 generate light in a narrow wavelength range of about 400-500 nanometers. In another embodiment of the invention, lighting elements 16 may generate light in wide band. Further, various configurations of lighting elements 16 may be provided on mouthpiece 12. For example, mouthpiece 12 may include one, two, or more lighting elements 16. The particular spacing of lighting elements 16 is determined and chosen, in part, to optimize the desired whitening or cleaning activity provided by the output light and the whitening agent.

Heating elements 18 may include Surface Mounted Device (SMD) resistors of values ranging from 0.1 ohm to 1M ohm. Further, the sizes of heating elements 18 may range from 01-02 to 12-10 mills. As shown, mouthpiece 12 includes temperature sensors 23 for determining the temperature of heat generated by heating elements 18. In an embodiment of the invention, only a single temperature sensor 23 is provided. In another embodiment of the invention, temperature sensors 23 may be distributed equally over the surface of mouthpiece 12. Mouthpiece 12 includes one or more layers of a whitening agent. The dental whitening is achieved by applying simultaneously the light generated by lighting elements 16, the heat generated by heating elements 18, and the chemical activity delivered by the whitening agent. Examples of whitening agent include a gel, paste or a liquid that may include hydrogen peroxide and carbamide peroxide for chemical process of dental whitening.

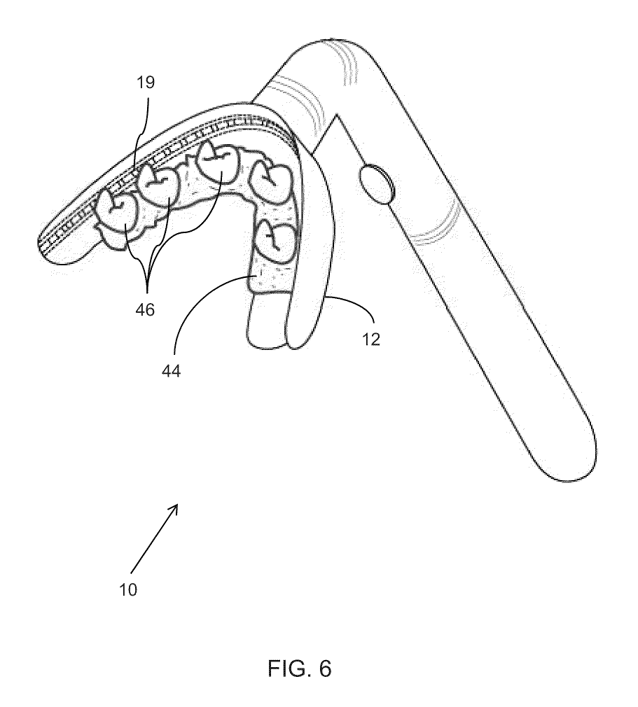

With reference to FIG. 6, an isometric view of device 10 supporting impression material on bite platform 22 of mouthpiece 12 is illustrated. This view represents a lateral-superior profile view from the perspective of the patient. As shown, bite platform 22 is partially covered by an impression material 44. FIG. 6 depicts the situation after taking impression of the teeth of the patient in impression material 44. Any commercially available impression material will be suited taking impression. For example, polyethers and polyvinyl siloxanes may be used for taking the impression. LH elements 19 surround impression material 44. Therefore, the patient can identify LH elements 19 that are located in front of teeth 46. Moreover, the patient can select LH elements 19 required to whiten any specific tooth from teeth 46, in case a generalized whitening of all of teeth 46 is not desired by the patient.

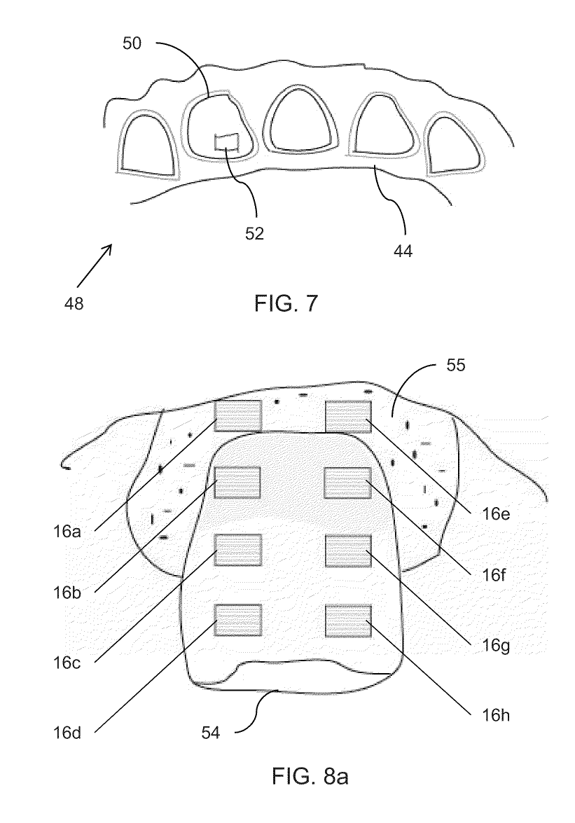

FIG. 7 is an exemplary upper view of a segment of teeth 48 for perforating the impression material corresponding to a tooth that is desired to be whitened. As shown, the segment includes five teeth 48 imprinted in on impression material 44. A commercially available sharp marker may be used to perforate impression material 44 of the imprint of a tooth 50 that is desired to be whitened. By perforating impression material 44 by a marker, a mark 52 can be produced on mouthpiece 12 to accurately mark LH elements 19 that should be activated for the purpose of whitening tooth 50.

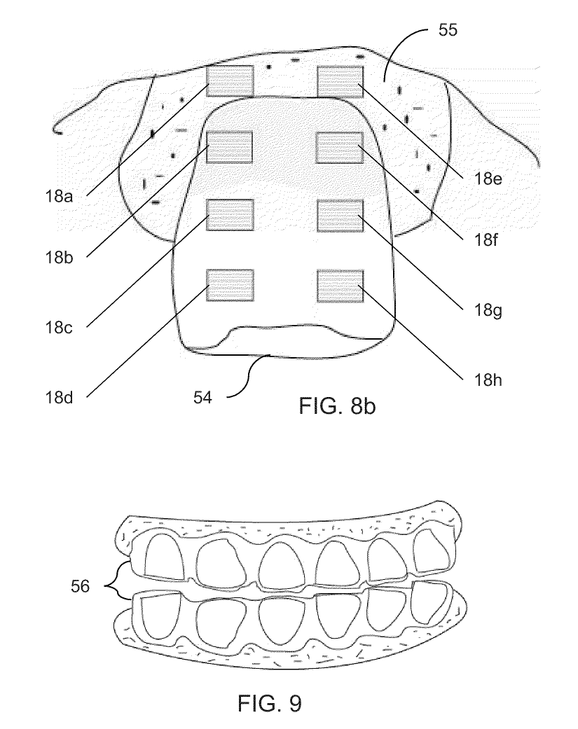

FIG. 8a is an exemplary front view of a tooth 54 covered by mouthpiece 12, illustrating lighting elements 16 placed on front of tooth 54. As shown, lighting elements 16 may cover diverse areas of tooth 54 and its gum 55. Therefore, the patient can select those lighting elements 16 that are mostly relevant for the whitening of tooth 54 and the particular zone at tooth 54. Moreover, the patient can control the power of each of lighting elements 16 to adapt it to the degree of whitening desired. As shown in this figure, the areas of tooth 54 covered by lighting elements 16b and 16f are discolored and will need more power for whitening than the areas covered by lighting elements 16d and 16h.

FIG. 8b is an exemplary front view of tooth 54 covered by mouthpiece 12, illustrating heating elements 18 placed on front of tooth 54. As shown, heating elements 18 may cover diverse areas of tooth 54 and its gum. Therefore, the patient can select those heating elements 18 that are mostly relevant for the whitening of tooth 54 and the particular zone at tooth 54. Moreover, the patient can control the power of each of heating elements 18 to adapt it to the degree of whitening desired. As shown in this figure, the areas of tooth 54 covered by heating elements 18b and 18f are discolored and will need more power for whitening than the areas covered by heating elements 18d and 18h.

FIG. 9 is a view of superior and inferior dental tray 56 as mounted on a teeth mold. The whitening agent may be placed in dental tray 56 and applied to one or more teeth 46. Upon proper placement of dental tray 56 in the mouth of the patient, the whitening agent bathes or covers the surface of the patient's one or more teeth. Thereafter, mouthpiece 12 may be placed in the mouth, secured by the biting teeth on the bite platform 22. As a result, layers of whitening agent may be contained in mouthpiece 12. Subsequently, light and heat may be directed to the visible portion of teeth 46, which are exposed to the whitening agent. Therefore, a chemical reaction with the whitening agent occurs, the effect of which is to enhance and/or accelerate the tooth whitening effect.

Dental tray 56 may include a variety of forms, for example, a dual tray for both of upper and lower one or more of teeth, a single tray for the upper or lower one or more of teeth 46, dental strips, dental tapes, and so forth. As shown in FIG. 9, dental tray 56 is a dual tray. Further, dental tray 56 may be generic to fit all mouth sizes or can be custom designed. Typically, dental tray 56 fit within the mouth of the patient and may cover all of the upper and/or lower one or more of teeth or a portion thereof. In an embodiment of the invention, dental tray 56 fits over both of the upper and/or lower one or more of teeth.

Dental tray 56 may be manufactured from any dental-grade material, such as but not limited to, polycarbonate, polyurethane, ethyl vinyl acetates and so forth. Further, dental tray 56 may be manufactured by various methods. For example, dental tray 56 may be made by making an impression of the teeth, and may be thermoformed over a mold caste on the impression. Typically, to use a minimal necessary amount of the whitening agent, dental tray 56 may be custom-made to fit snugly on the teeth, leaving a minimal space between dental tray 56 and surface of teeth, which has to be occupied by the whitening agent.

As also discusses above, the whitening agent may be in the form of for example, a gel, paste, a liquid, or a toothpaste. The whitening agent may be a material that imparts a dental whitening effect on teeth upon exposure. Typically, the whitening agents may include hydrogen peroxide and carbamide peroxide. Further, the whitening agent may be diluted to lessen the harmful effects due to prolonged exposure to the chemical composition and possible risks due to ingestion. Depending on the precise whitening agent being used, the concentration of the whitening agent may range from about 1% to 40% of whitening solution. The whitening agent may be provided in small plastic syringes, packets or in concentrated form. In an embodiment of the invention, the whitening agent is provided in the form of a small plastic syringe that may be injected or deposited onto dental tray 56. The syringe may contain suitable amounts of the whitening agent for a single application or multiple applications.

FIG. 10 is an isometric view of a cradle 58 of device 10, in accordance with an embodiment of the invention. Cradle 58 may include first ports 60 for receiving device 10, and second ports 62 for connecting device 10 to an external device. Example, of external device includes, but is not limited to, a computer, a laptop, a mobile phone, a smartphone and so forth. Second ports 62 may be used to transfer information between the external device and device 10. Examples of first ports 60 and second ports 62 include, but are not limited to, a Universal Serial Bus (USB), an Ethernet port, and so forth. A person skilled in the art will appreciate that other means of wirelessly transferring information such as Bluetooth, Infrared can also be used. In an embodiment of the invention, cradle 58 can provide power to device 10.

FIG. 11 is an exemplary view of device 10 connected to external device 64 through cradle 58. External device 64 may include software to enable selection of LH elements 19 to be activated/powered. Further, other parameters such as the intensity of the illumination, the intensity of the heating and the time of operation for each of LH elements 19 can be selected from external device 64. Therefore, when device 10 is connected to external device 10 through cradle 58, the selection made are transferred as information to programmable unit 32 as pre-stored selections and sequence. Then, on powering-on device 10, programmable unit 32 performs the pre-stored sequence, which is illuminating and heating each tooth as programmed and for the pre-stored time.

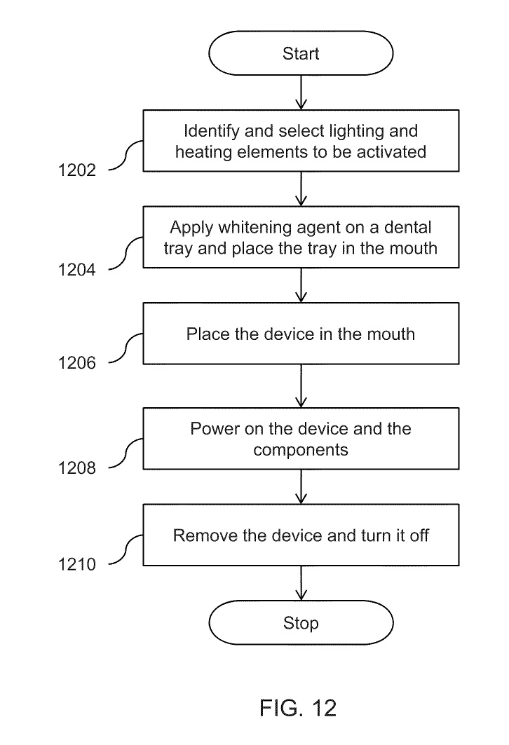

FIG. 12 is a block diagram illustrating a method for dental whitening, in accordance with an embodiment of the invention. A person skilled in the art will appreciate that the method is explained as an exemplary scenario where a patient may have a single or multiple discolored teeth for the sake of explanation. A dentist may take an impression of dental arches of the patient and prepare a custom-made dental tray. Further, the dentist may provide a whitening gel, and device 10.

At step 1202, the patient may identify LH elements 19 to be activated. To identify them, the impression material may be applied on bite platform 22 and insert mouthpiece 12 in the mouth. The shape of mouthpiece 12 adapts to the shape of the dental arches of the mouth due to slits 42 that allow flexibility to mouthpiece 12. Thereafter, device 10 is removed and the tooth or teeth to be whitened may be identified on the impression material. Further, the impression material may be perforated, for example by a marker to reach the hard surface of mouthpiece 12. As a result, the mark left by the perforation may indicate LH elements 19 that can be activated. Thereafter, LH elements 19 for performing whitening of desired teeth and area of the teeth may be selected by pressing buttons 30 of control unit 14.

At step 1204, the whitening agent may be applied on dental tray 56 and placed in the mouth. Subsequently, at step 1206, the patient may place device 10 in the mouth by biting on bite platform 22. At step 1208, device 10 including selected lighting elements 16, heating elements 18 and temperature sensors 23 may be powered on by pressing switch 24 of control unit 14. Thereafter, the patient may remove device 10 after a time period desired or as prescribed by the dentist. In an embodiment of the invention, the patient may lower the light emitted by lighting elements 16 and reduces the heat delivered by heating element 18, by turning the potentiometer of control unit 14. At step 1210, the patient may remove mouthpiece 12 and dental tray 56 from the mouth and turn it off. Further, mouthpiece 12 and dental tray 56 may be washed before storing them. Moreover, the patient may repeat the several times to achieve the desired result.

The LH elements 19 selected by the patient may be stored by programmable unit 32. Therefore, the patient may not be required to select the LH elements 19 till the desired results are achieved. Moreover, as explained, device 10 is portable, self-adjusted, and customizable and provides accelerated dental whitening due to combined effect of light and heat.

Embodiments of dental whitening device 10 provides the accelerated whitening, as it combines the chemical effect of the whitening agent, which is accelerated by the light and heat generated by LH elements 19. Further, device 10 can irradiate light and heat to selected teeth or tooth areas and is stable in the desired position during the time of usage. Moreover, device 10 can be used with most of the existing whitening agents and dental trays for whitening purposes, and may not require direct and constant professional supervision, as it implements well-known safe products. Further, device 10 is simple, reliable and cost effective, as it is composed of industry standard materials. Moreover, device 10 is easy and comfortable for the patient to use, as it is designed to adjust its shape to mouth shapes or oral cavities with different sizes and is small, so occupies a small fraction of the oral cavity's volume. Further, device 10 can be used within the confines of the home or at any convenient place, as it is portable. Moreover, device 10 is time saving, as it accelerates the whitening effect by light and heat, and saves appointments and visits to the dental offices.

As one of ordinary skill in the art will appreciate, the example system and method described herein can be modified. For example, certain steps can be omitted, certain steps can be carried out concurrently, and other steps can be added. Although particular embodiments of the invention have been described in detail, it is understood that the invention is not limited correspondingly in scope, but includes all changes, modifications and equivalents coming within the spirit and terms of the claims appended hereto.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A dental whitening device comprising:
a flexible mouthpiece comprising:
a bite platform having a horseshoe shape, wherein the bite platform is adapted to receive a plurality of mouth shapes;
at least one lighting element configured to generate light;
at least one heating element configured to generate heat;
a flexible printed circuit board; and
at least one temperature sensor configured to detect the temperature of the heat generated by said at least one heating elements; and
a control unit configured to selectively power said at least one lighting element and said at least one heating element.

2. The device of claim 1, wherein said bite platform comprises a plurality of segments separated by at least one slit, wherein said segment provide flexibility to said mouthpiece to receive said plurality of mouth shapes.

3. The device of claim 1, wherein said bite platform is adapted to the mouth shapes by using a boil-and-bite method.

4. The device of claim 1, wherein the mouthpiece comprises one or more layers of a whitening agent, wherein the dental whitening is achieved by applying simultaneously the light generated by said at least one lighting element, the heat generated by said at least one heating element and the chemical activity delivered by the whitening agent.

5. The device of claim 1, wherein said control unit comprises:
a power source configured to provide power to said at least one lighting element and said at least one heating element;
a switch configured to activate said control unit; and
a controller configured to selectively power said at least one lighting element and said at least one heating element.

6. The device of claim 5, wherein said controller comprises at least one of a potentiometer, pulse width modulator, and a pulse frequency modulator configured to control the current and voltage of power supplied to said at least one lighting element and said at least one heating element.

7. The device of claim 5, wherein said controller comprises a temperature control unit configured to control the temperature of the heat generated by said at least one heating element.

8. The device of claim 5, wherein said controller comprises:
at least one button configured to select at least one lighting element and said at least one heating element to be powered; and
a programmable unit configured to selectively power at least one lighting element and said at least one heating element based on a pre-stored selection.

9. The device of claim 5, wherein said controller comprises a device port configured to connect said device to an external device, wherein said external device enables selection of at least one lighting element and said at least one heating element to be powered.

10. The device of claim 1, wherein said at least one lighting element comprise light emitting diodes.

11. The device of claim 1, wherein said at least one heating element comprise resistors.

12. The device of claim 1, wherein said at least one lightning element is configured to emit light at a wavelength in the range of about 200 to 1100 nanometers.

13. The device of claim 1, wherein said at least one lightning element emits at least one of ultraviolet light, infrared light, and a combination of ultraviolet and infrared light.

14. A dental whitening device comprising:
a flexible mouthpiece comprising:
a bite platform having a horseshoe shape;
at least one lighting element configured to generate light;
at least one heating element configured to generate heat;
a flexible printed circuit board; and
at least one temperature sensor configured to detect the temperature of the heat generated by said at least one heating elements; and
a control unit configured to:
activate said at least one lighting element and said at least one heating element, based on a pre-stored selection and pre-stored sequence; and
control the temperature of the heat generated by said at least one heating elements, based on a predefined temperature range.

15. The device of claim 14, wherein said control unit comprises:
a power source configured to provide power to said at least one lighting element and said at least one heating element;
a switch configured to activate said control unit; and
a controller comprising:
a device port configured to connect said device to an external device, wherein said device receives programming information from said external device; and
a programmable unit configured to power at least one lighting element and said at least one heating element based on the programming information.

16. The device of claim 14, wherein said at least one lighting element comprise light emitting diodes.

17. The device of claim 14, wherein said at least one heating element comprise resistors.

18. A method for whitening of teeth comprising:
providing a portable dental whitening device, wherein the device comprises a mouthpiece and a control unit, and wherein the mouthpiece comprises at least one lighting element, at least one heating element, a printed circuit board and a bite platform having a horseshoe shape;
placing tooth whitening agent on a dental tray;
securing the dental tray on one or more teeth of a patient, whereby the tooth whitening agent coats at least one tooth;
securing the portable dental whitening device to one or more teeth of the patient by occluding the teeth on the bite platform;
activating said at least one lighting element for generating light and said at least one heating element for generating heat by using the control unit; and
exposing the at least one tooth with light generated by said at least one lighting element and heat generated by said at least one heating element, wherein the dental tray permits the light and heat to cause a reaction with the tooth whitening agent in order to whiten the at least one tooth of the patient.

19. The method of claim 18 further comprising selecting said at least one lighting element and said at least one heating element for activation.

20. The method of claim 18 further comprising:
detecting by said at least on temperature sensor the temperature of the heat generated by said at least one heating element; and
controlling by said control unit said temperature based on a predefined temperature range.
